(19) United States
(12) Patent Application Publication
(10) Pub. No.: US 2019/0393705 A1
(43) Pub. Date: Dec. 26, 2019

(54) PORTABLE CHARGING APPARATUS FOR A PORTABLE ELECTRONIC DEVICE

(71) Applicant: CHARGETAB INC., Hampstead (CA)

(72) Inventor: Mark Lieblein, Hampstead (CA)

(21) Appl. No.: 16/536,128

(22) Filed: Aug. 8, 2019

Related U.S. Application Data
(60) Provisional application No. 62/738,275, filed on Sep. 28, 2018.

(51) Int. Cl. H02J 7/00; H01R 24/28

(52) U.S. Cl. CPC H02J 7/0045; H01R 2107/00; H01R 24/28; H02J 7/0047

(57) ABSTRACT

A portable charging apparatus for charging a portable electronic device, the apparatus comprising: an apparatus body including a housing and an electrical power source; at least one charging head distinct from the apparatus body, each charging head including at least one charger-side electrical connector operatively connectable to a corresponding device-side electrical connector of the portable electronic device; and for each charging head, a connection cable having a proximal cable end permanently secured to the apparatus body and a distal cable end permanently secured to the charging head, the proximal cable end being operatively connected to the electrical power source and the distal cable end being operatively connected to the charger-side electrical connector to allow electrical power to be provided from the electrical power source to the charger-side electrical connector to thereby charge the portable electronic device when the charger-side electrical connector is connected to the corresponding device-side electrical connector.

### CROSS REFERENCE TO RELATED APPLICATIONS

This application claims priority to currently pending U.S. Provisional Application Ser. No. 62/738,275, filed on Sep. 28, 2018, the specification of which is incorporated herein by reference.

### TECHNICAL FIELD

The technical field generally relates to portable charging apparatuses and more specifically to portable charging apparatuses for portable electronic devices and to methods for charging a portable electronic device.

### BACKGROUND

Portable electronic devices such as smartphones, tablets and laptop computers have become ubiquitous.

Most of these portable electronic devices are powered by one or more rechargeable batteries which allows the device to be carried and used without requiring the device to be continuously plugged in an electrical outlet. As the portable electronic devices are used, the batteries become depleted and need to be charged in order to allow the electronic device to be powered again for a period of time.

Rechargeable batteries can sometimes be charged using a charger device connected to an electrical outlet. However, in some circumstances, it may not be possible or practical to have access to an electrical outlet to charge the rechargeable batteries.

Some portable charging devices have been offered, but existing charging devices are often complex, cumbersome, unreliable, expensive to manufacture and/or offer poor charging performances.

### SUMMARY

According to one aspect, there is provided a portable charging apparatus for charging a portable electronic device, the charging apparatus comprising: an apparatus body including a housing and an electrical power source housed within the housing; at least one charging head distinct from the apparatus body, each charging head including at least one charger-side electrical connector operatively connectable to a corresponding device-side electrical connector of the portable electronic device; and for each charging head, a connection cable extending between the apparatus body and the charging head, the connection cable having a proximal cable end permanently secured to the apparatus body and a distal cable end permanently secured to the charging head, the proximal cable end being operatively connected to the electrical power source and the distal cable end being operatively connected to the charger-side electrical connector to allow electrical power to be provided from the electrical power source to the charger-side electrical connector to thereby charge the portable electronic device when the charger-side electrical connector is connected to the corresponding device-side electrical connector.

In at least one embodiment, each charging head includes an elongated body having a first body end and a second body end located opposite the first body end, the distal cable end being secured to the first body end and the charger-side electrical connector being located at the second body end.

In at least one embodiment, the portable electronic device is received in a portable device case including a port opening aligned with the device-side electronic connector, the elongated body being sized and shaped for allowing the elongated body to extend through the port opening to allow the charger-side electrical connector to engage the corresponding device-side electrical connector.

In at least one embodiment, the charger-side electrical connector includes a male electrical connector and the corresponding device-side electrical connector includes a female electrical connector.

In at least one embodiment, the male electrical connector extends from the second body end and away from the elongated body along a longitudinal axis of the elongated body.

In at least one embodiment, the connection cable is sufficiently flexible for preventing disengagement of the charger-side electrical connector from the corresponding device-side electrical connector when the charger-side electrical connector is engaged with the device-side electrical connector and the portable electronic device is moved laterally relative to the apparatus body.

In at least one embodiment, the charging apparatus further comprises a controller housed in the housing, the controller being operatively connected to the electrical power source to control at least one of a voltage and of a current delivered by the electrical power source through the connection cable.

In at least one embodiment, the charging apparatus further comprises a switch operatively connected to the controller for selectively allowing and preventing supply of electrical power from the electrical power source to the portable electronic device.

In at least one embodiment, the charging apparatus further comprises a light emitting diode operatively connected to the controller to provide an indication that the controller is in a charging configuration in which electrical power is supplied from the electrical power source to the portable electronic device.

In at least one embodiment, the housing includes at least one cable opening, each cable opening being sized and shaped to allow the proximal end of a corresponding connection cable to extend therethrough for connection to the electrical power source.

In at least one embodiment, the housing is made of a paper product.

In at least one embodiment, the housing includes a first housing portion and a second housing portion substantially identical to the first housing portion, the first and second housing portions being securable together to form the housing.

In at least one embodiment, each housing portion includes a peripheral rim and an assembly flange extending outwardly from the peripheral rim, the assembly flange of the first housing portion being securable to the assembly flange of the second housing portion.

In at least one embodiment, each connection cable is substantially flat.

In at least one embodiment, the electrical power source includes a battery.

In at least one embodiment, the battery is rechargeable.

In at least one embodiment, the battery has an energy capacity of more than about 1500 mAh.

In at least one embodiment, the battery has an energy capacity of about 1800 mAh.

In at least one embodiment, the battery has an energy capacity of about 2500 mAh.

According to another aspect, there is also provided a method for charging a portable electronic device, the method comprising: providing a portable charging apparatus as described above; connecting the charger-side electrical connector of the portable charging apparatus to a device-side electrical connector of a portable electronic device.

In at least one embodiment, the portable charging apparatus includes a controller housed in the housing and operatively connected to the electrical power source and a switch operatively connected to the controller for selectively allowing and preventing supply of electrical power from the electrical power source to the portable electronic device, the method further comprising: operating the switch to set the controller in a charging configuration in which electrical power is supplied from the electrical power source to the male electrical connector.

In at least one embodiment, providing the portable charging apparatus comprises: providing a sealed package containing the portable charging apparatus; opening the sealed package to access the portable charging apparatus.

In at least one embodiment, the method further comprises: after the electrical power source has been depleted, disposing of the portable charging apparatus.

In at least one embodiment, the method further comprises: after the electrical power source has been at least partially depleted, recharging the electrical power source.

According to yet another aspect, there is also provided a portable charging apparatus for charging a portable electronic device, the charging apparatus comprising: an apparatus body including a housing and an electrical power source housed within the housing; a charging head distinct from the apparatus body, the charging head including an elongated body and a male electrical connector extending from the body for engaging a corresponding female electrical connector of the portable electronic device; a connection cable extending between the apparatus body and the charging head to allow the charging head to be disposed away from the apparatus body, the connection cable having a proximal end operatively connected to the electrical power source and a distal end operatively connected to the male electrical connector to allow electrical power to be provided from the electrical power source to the male electrical connector, the proximal end of the connection cable being permanently secured to the apparatus body.

### BRIEF DESCRIPTION OF THE DRAWINGS

For a better understanding of the embodiments described herein and to show more clearly how they may be carried into effect, reference will now be made, by way of example only, to the accompanying drawings which show at least one exemplary embodiment, and in which:

FIG. 1 is a perspective view of a portable electronic device and a portable charging apparatus, in accordance with one embodiment, with the portable charging apparatus operatively connected to the portable electronic device;

FIG. 2 is another perspective view of the portable electronic device and the portable charging apparatus illustrated in FIG. 1, with the portable charging apparatus disconnected from the portable electronic device

FIG. 3 is a top perspective view of the portable charging apparatus illustrated in FIG. 1;

FIG. 4 is a top plan view of the portable charging apparatus illustrated in

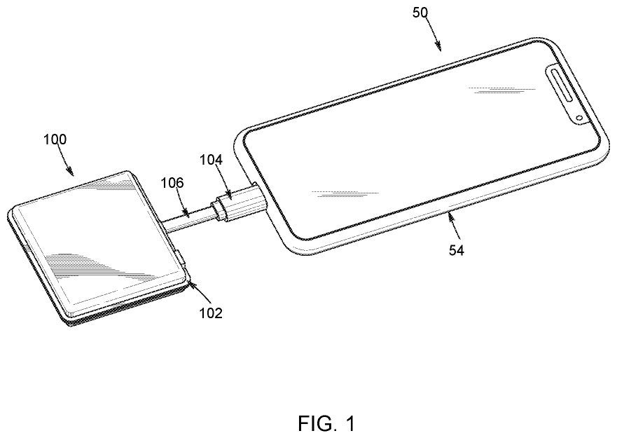

FIG. 1;

FIG. 5 is a bottom plan view of the portable charging apparatus illustrated in FIG. 1;

FIG. 6 is a front elevation view of the portable charging apparatus illustrated in FIG. 1;

FIG. 7 is a rear elevation view of the portable charging apparatus illustrated in FIG. 1;

FIG. 8 is a left side elevation view of the portable charging apparatus illustrated in FIG. 1;

FIG. 9 is a right side elevation view of the portable charging apparatus illustrated in FIG. 1; and

FIG. 10 is another top plan view of the portable charging apparatus shown in FIG. 1, with a first housing portion of a housing of the apparatus removed to show a control circuit and a battery of the apparatus housed within the housing.

### DETAILED DESCRIPTION

It will be appreciated that, for simplicity and clarity of illustration, where considered appropriate, reference numerals may be repeated among the figures to indicate corresponding or analogous elements or steps. In addition, numerous specific details are set forth in order to provide a thorough understanding of the exemplary embodiments described herein. However, it will be understood by those of ordinary skill in the art, that the embodiments described herein may be practiced without these specific details. In other instances, well-known methods, procedures and components have not been described in detail so as not to obscure the embodiments described herein. Furthermore, this description is not to be considered as limiting the scope of the embodiments described herein in any way but rather as merely describing the implementation of the various embodiments described herein.

For the sake of simplicity and clarity, namely so as to not unduly burden the figures with several references numbers, not all figures contain references to all the components and features, and references to some components and features may be found in only one figure, and components and features of the present disclosure which are illustrated in other figures can be easily inferred therefrom. The embodiments, geometrical configurations, materials mentioned and/or dimensions shown in the figures are optional, and are given for exemplification purposes only.

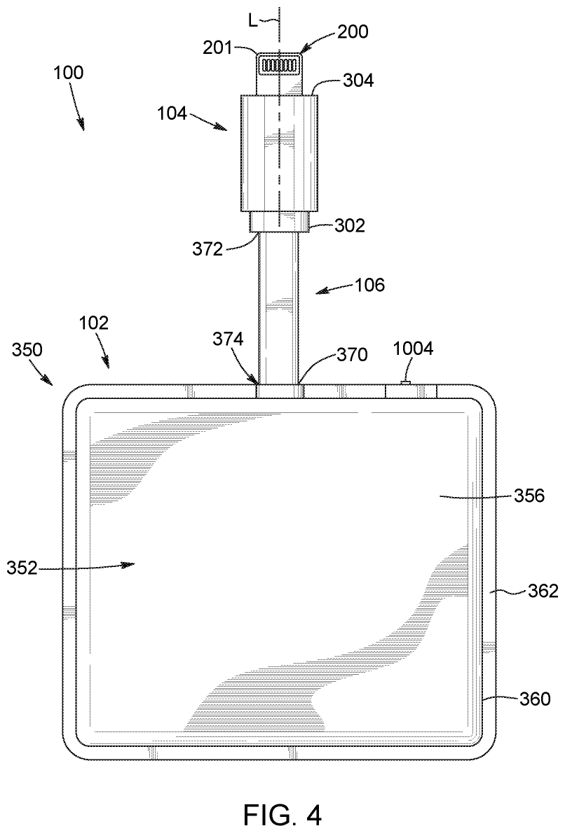

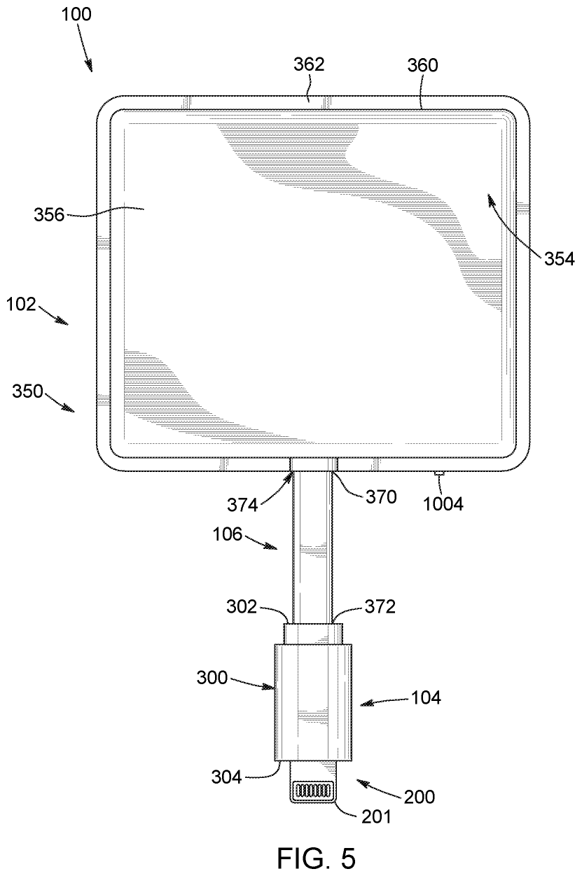

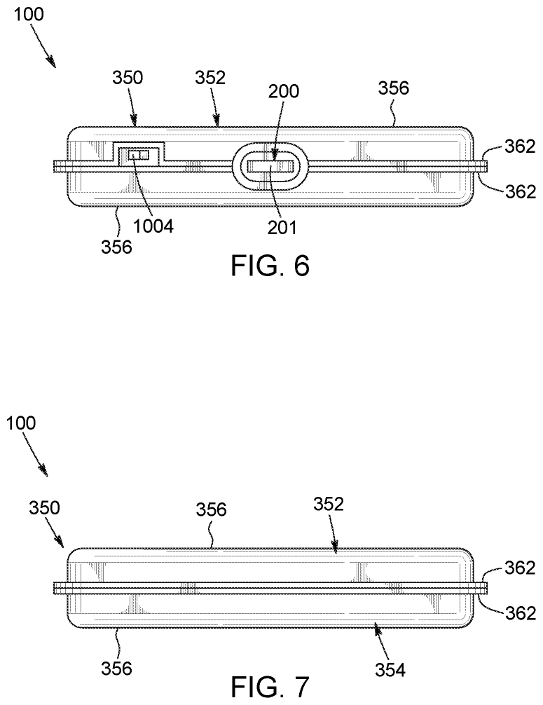

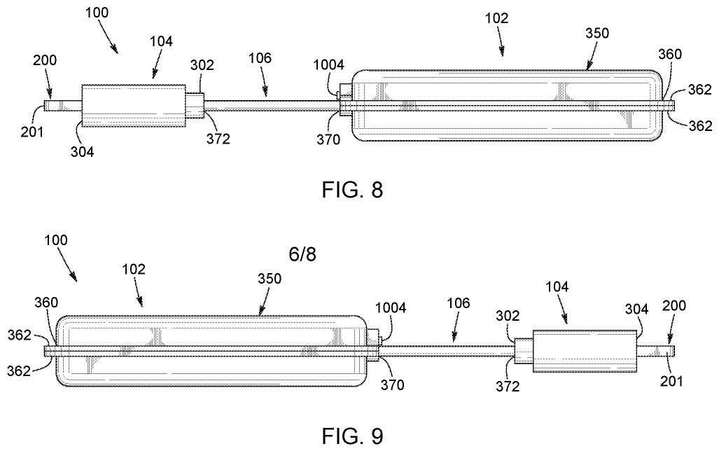

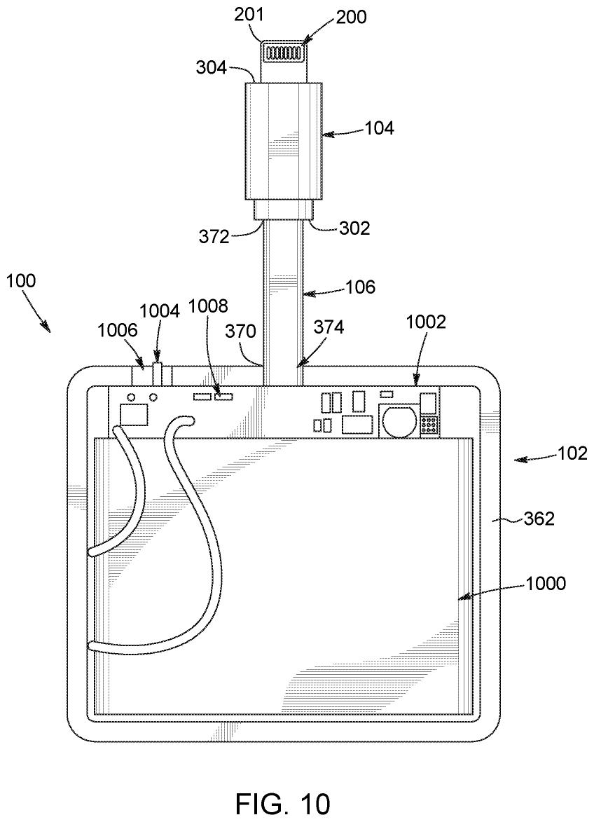

Referring to FIGS. 1 to 10, there is shown a portable electronic device 50 and a portable charging apparatus 100, in accordance with one embodiment. The portable charging apparatus 100 is operatively connectable to the portable electronic device 50 for charging or recharging the portable electronic device 50. More specifically, the portable electronic device 50 includes an internal battery, not shown, which powers the portable electronic device 50. As the portable electronic device 50 is used, the internal battery is drained. The portable charging apparatus 100 is configured to charge or recharge the internal battery of the portable electronic device 50 when operatively connected to the portable electronic device 50.

Alternatively, the portable electronic device 50 may not include an internal battery and the portable charging apparatus 100 may be used as a main energy source to power the portable electronic device 50.

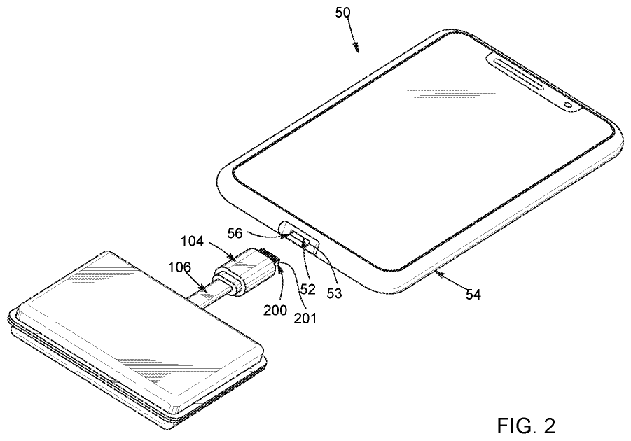

In the illustrated embodiment, the portable electronic device 50 is a smartphone, as shown in FIGS. 1 and 2, but, alternatively, the portable electronic device 50 could instead include any other type of portable electronic device such as, but not limited to, a cellular phone, a tablet, a digital camera, a portable music player, an e-reading device, a handheld gaming device, a portable computer, a wearable electronic device, a GPS navigation device, a portable vaporizer such as an electronic cigarette, or the like.

The charging apparatus 100 includes an apparatus body 102, a charging head 104 distinct from the body 102 and disposed away from the body 102 and a connection cable 106 extending between the body 102 and the charging head 104. The charging head 104 includes a charger-side electrical connector 200, best shown in FIG. 2, configured to operatively engage a corresponding device-side electrical connector 52 of the portable electronic device 50. The device-side electrical connector 52 is operatively connected to the internal battery of the portable electronic device 50 such that electrical power supplied to the device-side electrical connector 52 can charge the internal battery.

In the illustrated embodiment, the charger-side electrical connector 200 is a male electrical connector 201 and the device-side electrical connector 52 is a female electrical connector 53 sized and shaped to receive the male electrical connector 201, as best shown in FIG. 2. Alternatively, the charger-side electrical connector 200 could instead be a female electrical connector and the device-side electrical connector 52 could be a male electrical connector. In yet another embodiment, both the charger-side electrical connector 200 and the device-side electrical connector 52 could be hermaphrodite electrical connectors.

As best shown in FIG. 10, the apparatus body 102 is sized and shaped to receive an electrical power source such as a battery 1000, which is operatively connected to the male electrical connector 201 via the connection cable 106 to allow the battery 1000 to charge the portable electronic device 50 when the male electrical connector 201 is connected to the female electrical connector 53 of the portable electronic device 50.

In the embodiment illustrated in FIG. 2, the portable electronic device 50 is received in a portable device case 54 which substantially cover a portion of the electronic device 50 to protect the electronic device 50. Specifically, the portable device case 54 may be similar to existing conventional cases and be made of a plastic polymer or an elastomeric material which extends substantially snuggly around at least a portion of the electronic device 50 to thereby form a protective skin around the electronic device 50.

In the illustrated embodiment, the portable device case 54 includes a port opening 56 which is aligned with the female electrical connector 53 of the portable electronic device 50. It will be understood that the portable device case 54 has a certain thickness such that the port opening 56 defines a recess at the bottom of which is located the female electrical connector 53 of the portable electronic device 50. This configuration may make the female electrical connector 53 relatively difficult to access or reach. When using a conventional charging apparatus, the user may therefore need to remove the portable electronic device 50 from the portable device case 54 when charging the device 50 in order to gain access to the female electrical connector 53.

To allow the male electrical connector 201 to reach and engage the female electrical connector 53, the charging head 104 is sized and shape such that it may extend through the port opening 56. Furthermore, by providing the connection cable 106 between the apparatus body 102 and the charging head 104, the charging head 104 is therefore spaced or disposed away from the apparatus body 102 and may therefore be located into the port opening 56 such that the male electrical connector 201 engages the female electrical connector 53 without the apparatus body 102 interfering with the portable device case 54 or the portable electronic device 50. This configuration further eliminates the need to remove the portable electronic device 50 from the portable device case 54 when charging the device 50.

It will also be appreciated that the male electrical connector 201 may be in an efficient charging configuration only when fully engaged with the female electrical connector 53. In the illustrated embodiment, the connection cable 106 has a certain degree of flexibility which is sufficient to prevent the male electrical connector 201, when engaged with the female electrical connector 53, to become disengaged from the female electrical connector 53 when the apparatus body 102 is moved or at least angled slightly laterally relative to the portable electronic device 50. The connection cable 106 therefore ensures that the portable charging apparatus 100 charges the portable electronic device 50 continuously with optimal charging performance when the male electrical connector 201 is connected to the female electrical connector 53.

To further ensure optimal charging performance of the portable charging apparatus 100, the connection cable 106 is further permanently secured to the apparatus body 102. This prevents the connection cable 106 from becoming accidently disconnected from the apparatus body 102 and the battery 1000 within the apparatus body 102, such as when an external force is applied to the apparatus body 102, which would interrupt the charging of the portable electronic device 50. Additionally, this configuration prevents the connection cable 106 from becoming misplaced and lost, which could cause a user to spend time, effort and resources to search for the misplaced connection cable or to replace the lost connection cable. This configuration further eliminates the need to provide an additional connection interface between the connection cable 106 to the apparatus body 102 which may be damaged during use and may add unnecessary costs to the manufacturing of the portable charging apparatus 100.

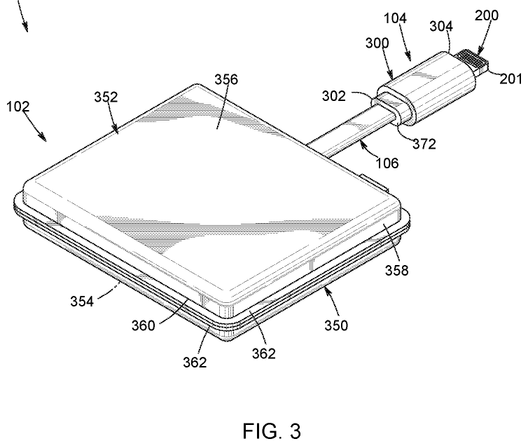

Now referring specifically to FIGS. 3 to 9, the charging head 104 includes a rigid elongated body 300 which extends along a longitudinal axis L. The elongated body 300 has a cable end 302 and a connector end 304 opposite the cable end 302. The cable end 302 is connected to the connection cable 106, while the male electrical connector 200 extends from the connector end 304 of the elongated body 300 and away from the elongated body 300 along the longitudinal axis L of the elongated body 300.

In the illustrated embodiment, the charging head 104 has a generally oblong and obround cross-section and is sized and shaped to fit relatively snuggly into a similarly oblong and obround port opening 56. Alternatively, the charging head 104 may have any other shape which a skilled person would consider to be appropriate.

In the illustrated embodiment, the male electrical connector 201 includes a Lightning™ male connector and the female electrical connector 53 includes a corresponding Lightning™ female receptacle or port or connector. Alternatively, the male electrical connector 201 may include any other types of suitable electrical connectors including, but not limited to, USB-A connector, USB-B connector, USB-C connector, Mini USB-A connector, Mini USB-B connector, Micro USB-A connector, Micro USB-B connector, 30-pin dock connector, PDMI connector, 1394 connector or the like. In another embodiment, the male electrical connector 201 could instead include a “dual tip” or “two-in-one” reversible connector which defines a first type of connector selected from the above list when oriented in a first orientation relative to the female electrical connector 53 and a second type of connector selected from the above list when rotated by 180 degrees relative to the first orientation.

Still in the illustrated embodiment, the elongated body 300 has a length, corresponding to the distance between the cable end 302 and the connector end 304, which is greater than a thickness of the portable device case 54 such that the cable end 302 is located outside of the port opening 56 of the portable device case 54. The cable end 302 therefore remains accessible to the user when the male electrical connector 201 fully engages the female electrical connector 53.

This configuration allows the charging head 104 to be manipulated by the user who can engage the male electrical connector 201 with the female electrical connector 53 and disengage the male electrical connector 201 from the female electrical connector 53 by manually pulling or pushing on the cable end 302 of the elongated body 300.

Alternatively, the charging head 104 may have another configuration. For example, instead of including an elongated body, the charging head 104 could instead be L-shaped and include first and second elongated portions extending perpendicularly to each other. The first elongated portion could include be connected to the connection cable 106 while the male electrical connector 201 could be provided on the second elongated portion, with the second elongated portion having a length which is greater than a thickness of the portable device case 54 to facilitate the connection of the charging head 104 to the electronic device 50 as described above.

In yet another embodiment, the charging head 104 could include more than one charger-side electrical connectors 200. The charger-side electrical connectors could be different from each other to allow the charging apparatus 100 to be used to charge multiple portable electronic devices, with each electronic device having a different type of device-side electrical connector. For example, the charging head 104 could include a first charger-side electrical connector, such as a Lightning™ male connector, and a second charger-side electrical connector, such as a Micro USB-B connector. In this embodiment, both the first and second charger-side electrical connectors could be operatively connected to the electrical power source to provide electrical power to the electronic device connected to the corresponding first or second charger-side electrical connector. The charging head 104 could even be configured to be simultaneously connected to multiple portable electronic devices 50, each portable electronic device 50 being connected to a corresponding charger-side electrical connector, to allow the multiple portable electronic devices 50 to be simultaneously charged. It will be appreciated that this configuration may allow a single model of portable charging apparatus to be manufactured for multiple types of electrical connectors as opposed to manufacturing a different model of portable charging apparatus for each type of electrical connector, which may reduce the costs of manufacturing the portable charging apparatus.

Referring now to FIGS. 3 to 10, the apparatus body 102 includes a housing 350 which houses the battery 1000. More specifically, the housing 350 is hollow and includes first and second housing portions 352, 354 which are secured together. It will be understood that providing the housing 350 in two housing portions 352, 354 allows the battery 1000 and other components to be easily installed into the housing 350 by placing the components in one of the first and second housing portions 352, 354 and securing the other housing portion 352, 354 to the first one of the housing portions 352, 354.

In the illustrated embodiment, the first and second housing portions 352, 354 are substantially identical to each other, which may advantageously facilitate the manufacturing of the housing 350 and thereby reduce the cost of manufacturing the housing 350.

Each housing portion 352, 354 includes a planar face 356 and a sidewall 358 extending away from the planar face 356 and defining a peripheral rim 360 of the housing portion 352, 354. Each housing portion 352, 354 further includes an assembly flange 362 which extends outwardly from the peripheral rim 360. In the illustrated embodiment, the assembly flange 362 extends generally continuously around the peripheral rim 360. Alternatively, the assembly flange 362 could instead include a single tab extending outwardly from the peripheral rim 360, or a plurality of spaced-apart tabs extending outwardly from the peripheral rim 360.

It will be understood that since the first and second housing portions 352, 354 are substantially identical to each other, the assembly flanges 362 of the first and second housing portions 352, 354 are similarly sized and shaped, and therefore can be placed against each other and secured to each other to form the housing 350. In the illustrated embodiment, the assembly flanges 362 of the first and second housing portions 352, 354 are glued to each other using an adhesive substance, but may alternatively be secured to each other using other securing means which a skilled person would consider to be suitable.

Alternatively, the first and second housing portions 352, 354 may not be identical to each other, but the assembly flanges 362 of the first and second housing portions 352, 354 may still be similarly sized and shaped such that they may be placed against each other and secured to each other as described above.

In yet another embodiment, the assembly flanges 362 of the first and second housing portions 352, 354 may be differently sized and/or shaped from each other but may still be adapted to be placed against each other and secured to each other.

In still another embodiment, the first and/or second housing portions 352, 354 may not include any flanges and the first and second housing portions 352, 354 may be secured to each other using other securing means.

In yet another embodiment, instead of first and second housing portions 352, 354, the housing 350 may include a single, unitary piece such as a paper or cardboard sheet folded onto itself, or may include more than two distinct housing portions assembled together to form the housing 350.

It will be appreciated that the charging apparatus 100 may be manufactured so as to be disposable. More specifically, the charging apparatus 100 may be manufactured to be disposable after the battery 1000 has been depleted. In this embodiment, the housing 350 may be manufactured using recyclable or biodegradable material. More specifically, in the illustrated embodiment, the housing 350 is made of a paper product such as cardboard or paperboard, molded pulp or the like. It will be appreciated that this provides a lightweight but still relatively robust protection of the battery 1000 and other components housed in the housing against water, dirt and other contaminants, while allowing the cost of manufacturing the housing 350 to be relatively low. Alternatively, the housing 350 may be made of another type of material such as polystyrene or the like.

In yet another embodiment, instead of being disposable, the battery 1000 may be rechargeable. Specifically, the charger-side electrical connector 200 may be adapted to be operatively connected to an external power source, either directly or via a suitable adapter, to recharge the battery 1000. In this embodiment, instead of being manufactured from a recyclable or biodegradable material such as a paper product, the housing 350 could instead be made from a more durable material such as a rigid plastic polymer, a metal or the like. Alternatively, the housing 350 could still be made from a paper product to keep the cost of manufacturing the charging apparatus 100 relatively low.

As shown in FIG. 10, the housing 350 is generally rectangular and is sized and shaped to snugly receive the battery 1000, which is also rectangular. This configuration may prevent movement of the battery 1000 within the housing 250 as the portable charging apparatus 100 is manipulated. The battery 1000 may further be secured within the housing 350 using other means such as glue or the like.

The battery 1000 could include any suitable portable battery such as a lithium-ion battery, a lithium-metal battery, or any other type of battery which a skilled person would consider to be suitable. The battery 1000 may further have an energy capacity of more than about 1500 mAh. For example, in one embodiment, the battery 1000 has an energy capacity of about 1800 mAh. In another embodiment, the battery 1000 has an energy capacity of about 2500 mAh. It will be understood that the battery 1000 may have one of various other energy capacities, and may even have an energy capacity of less than about 1500 mAh.

As further shown in FIG. 1, the portable charging apparatus 100 further includes a controller such as a control circuit 1002 which is housed in the housing 350, adjacent the battery 1000. The control circuit 1002 is operatively connected to the battery 1000 and is configured to control at least one parameter of the delivery of electrical current to the portable electronic device 50. Specifically, the control circuit 1002 may be configured to control the power, the current and/or voltage of the electrical current being delivered by the battery 1000.

In one embodiment, the control circuit 1002 may further be configured to throttle and/or interrupt the supply of electrical power to the portable electronic device 50 upon detection of a predetermined condition such as a temperature of the battery 1000 rising above a predetermined level, a short circuit in at least one of the male electrical connector 201, the connection cable 106 and the battery 1000, or any other condition in which it may be desirable or necessary to control the supply of electrical power to the portable electronic device 50.

Still in the illustrated embodiment, the portable charging apparatus 100 further includes a switch 1004 operatively connected to the control circuit 1002 for selectively allowing and preventing delivery of electrical current from the battery 1000 to the portable electronic device 50. As best shown in FIG. 10, the switch 1004 is accessible through a switch opening 1006 defined in the housing 350. Alternatively, the portable charging apparatus 100 may not include a switch.

Still in the illustrated embodiment, the portable charging apparatus 100 further includes a light emitting diode (or LED) 1008 operatively connected to the control circuit 1002 to provide an indication that the control circuit 1002 is in a charging configuration in which electrical current is delivered from the battery 1000 to the portable electronic device 50. Alternatively, the portable charging apparatus 100 may include another type of charging configuration indicator, or may not include any charging configuration indicator.

In the illustrated embodiment, the connection cable 106 includes a proximal end 370 which is operatively connected to the battery 1000 via the control circuit, as best shown in FIG. 10, and a distal end 372 connected to the cable end 302 of the charging head 104. Specifically, the housing 350 includes a cable opening 374 sized and shaped to allow the proximal end 370 of the connection cable 106 to be connected to the control circuit 1002.

In the illustrated embodiment, the connection cable 106 may be sufficiently long to space the charging head 104 away from the apparatus body 102, as explained above, while being sufficiently short to prevent the connection cable 106 to become tangled and to prevent unnecessary material to be used during the manufacturing of the portable charging apparatus 100.

Still in the illustrated embodiment, the connection cable 106 is generally flat. Specifically, the connection cable 106 extends generally laterally from the housing 350 and is disposed such that the connection cable 106 extends in a plane parallel to the planar faces 356 of the first and second housing portions 352, 354. In this configuration, as shown in FIG. 1, the connection cable 106 further extends in a plane parallel to the portable electronic device 50 (i.e. the smartphone) being charged. This configuration allows both the portable electronic device 50 and the portable charging apparatus 100 to be laid flat on a surface when the portable charging apparatus 100 is connected to the portable electronic device 50. Alternatively, the connection cable 106 may have any other shape which a skilled person would consider to be suitable.

It will be appreciated that the portable charging apparatus 100 may be manufactured so as to be disposable after a single use, once the battery 100 has been partially or fully depleted. In one embodiment for example, the portable charging apparatus 100 may be manufactured, pre-charged and provided in a sealed package. It will be understood that the sealed package may help preserve the battery's charge and thus extend the shelf life of the portable charging apparatus 100. The sealed package may further be substantially weatherproof to protect the portable charging apparatus 100 from dust and/or humidity. The sealed package containing the portable charging apparatus 100 may be made available for purchase by customers at a point of sale such as convenience stores, gift shops, electronic stores, airport shops, kiosks or the like.

To use the portable charging apparatus 100, the user may open the sealed package to access the portable charging apparatus 100 and remove the portable charging apparatus 100 from the opened package. The male electrical connector 201 of the portable charging apparatus 100 may then be connected to the female electrical connector 53 of the portable electronic device 50 to be charged.

The switch 1004 may further be activated to allow the battery 1000 to provide electrical current to the portable electronic device 50. Once the battery 1000 has been partially or fully depleted, the male electrical connector 201 of the portable charging apparatus 100 may be disconnected to the female electrical connector 53 and the user may dispose of the portable charging apparatus 100, which can be thrown away, recycled or destroyed.

As explained above, instead of being disposable, the portable charging apparatus 100 could instead be reusable at least twice. Specifically, once the battery 1000 has been depleted at least partially by charging a portable electronic device 50, the male electrical connector 201 could be operatively connected to an external power source, either directly or via an adapter, to be recharged at least partially. The male electrical connector 201 could then be reconnected to the same portable electronic device 50 or to another portable electronic device 50. In this embodiment, instead of being provided pre-charged within the sealed package, the battery 1000 may not be charged within the sealed package. In this embodiment, the battery 1000 may first need to be charged once the sealed package has been opened and the charging apparatus 100 has been removed from the opened package. Once the battery 1000 has been charged, the charging apparatus 100 can then be used to charge the electronic device 50.

It will be appreciated that the charging apparatus 100 as described above is configured to be portable. Specifically, the charging apparatus 100 is substantially compact so as to easily fit in a pocket or a handbag of a user and has a substantially low weight, especially in an embodiment in which the housing 350 is made of a paper product.

It will also be appreciated that the arrangements described above are merely provided as examples, and that many alternative configurations may be considered. For example, the portable charging apparatus 100 could have instead multiple connection cables with different connectors to allow the same portable charging apparatus 100 to be connected to various electronic devices having various types of connectors.

Furthermore, although the connectors 200, 52 of the portable charging apparatus 100 and of the portable electronic device 50 have been described above respectively as a male electrical connector and a female electrical connector, the portable charging apparatus 100 may instead include a female electrical connector and the portable electronic device 50 may include a male electrical connector. In yet another embodiment, instead of including male and female connectors, both connectors of the portable charging apparatus 100 and of the portable electronic device 50 could instead be hermaphrodite connectors.

In yet another embodiment, instead of including a single battery 1000, the charging apparatus 100 could instead include a plurality of batteries connected together in series or in parallel.

While the above description provides examples of the embodiments, it will be appreciated that some features and/or functions of the described embodiments are susceptible to modification without departing from the spirit and principles of operation of the described embodiments. Accordingly, what has been described above has been intended to be illustrative and non-limiting and it will be understood by persons skilled in the art that other variants and modifications may be made without departing from the scope of the invention as defined in the claims appended hereto.

1. A portable charging apparatus for charging a portable electronic device, the charging apparatus comprising:
an apparatus body including a housing and an electrical power source housed within the housing;
at least one charging head distinct from the apparatus body, each charging head including at least one charger-side electrical connector operatively connectable to a corresponding device-side electrical connector of the portable electronic device; and
for each charging head, a connection cable extending between the apparatus body and the charging head, the connection cable having a proximal cable end permanently secured to the apparatus body and a distal cable end permanently secured to the charging head, the proximal cable end being operatively connected to the electrical power source and the distal cable end being operatively connected to the charger-side electrical connector to allow electrical power to be provided from the electrical power source to the charger-side electrical connector to thereby charge the portable electronic device when the charger-side electrical connector is connected to the corresponding device-side electrical connector.

2. The charging apparatus as claimed in claim 1, wherein each charging head includes an elongated body having a first body end and a second body end located opposite the first body end, the distal cable end being secured to the first body end and the charger-side electrical connector being located at the second body end.

3. The charging apparatus as claimed in claim 2, wherein the portable electronic device is received in a portable device case including a port opening aligned with the device-side electronic connector, the elongated body being sized and shaped for allowing the elongated body to extend through the port opening to allow the charger-side electrical connector to engage the corresponding device-side electrical connector.

4. The charging apparatus as claimed in claim 2, wherein the charger-side electrical connector includes a male electrical connector and the corresponding device-side electrical connector includes a female electrical connector.

5. The charging apparatus as claimed in claim 4, wherein the male electrical connector extends from the second body end and away from the elongated body along a longitudinal axis of the elongated body.

6. The charging apparatus as claimed in claim 1, wherein the connection cable is sufficiently flexible for preventing disengagement of the charger-side electrical connector from the corresponding device-side electrical connector when the charger-side electrical connector is engaged with the device-side electrical connector and the portable electronic device is moved laterally relative to the apparatus body.

7. The charging apparatus as claimed in claim 1, further comprising a controller housed in the housing, the controller being operatively connected to the electrical power source to control at least one of a voltage and of a current delivered by the electrical power source through the connection cable.

8. The charging apparatus as claimed in claim 7, further comprising a switch operatively connected to the controller for selectively allowing and preventing supply of electrical power from the electrical power source to the portable electronic device.

9. The charging apparatus as claimed in claim 8, further comprising a light emitting diode operatively connected to the controller to provide an indication that the controller is in a charging configuration in which electrical power is supplied from the electrical power source to the portable electronic device.

10. The charging apparatus as claimed in claim 1, wherein the housing includes at least one cable opening, each cable opening being sized and shaped to allow the proximal end of a corresponding connection cable to extend therethrough for connection to the electrical power source.

11. The charging apparatus as claimed in claim 1, wherein the housing is made of a paper product.

12. The charging apparatus as claimed in claim 1, wherein the housing includes a first housing portion and a second housing portion substantially identical to the first housing portion, the first and second housing portions being securable together to form the housing.

13. The charging apparatus as claimed in claim 12, wherein each housing portion includes a peripheral rim and an assembly flange extending outwardly from the peripheral rim, the assembly flange of the first housing portion being securable to the assembly flange of the second housing portion.

14. The charging apparatus as claimed in claim 1, wherein each connection cable is substantially flat.

15. The charging apparatus as claimed in claim 1, wherein the electrical power source includes a battery.

16. The charging apparatus as claimed in claim 15, wherein the battery is rechargeable.

17. The charging apparatus as claimed in claim 15, wherein the battery has an energy capacity of more than about 1500 mAh.

18. The charging apparatus as claimed in claim 17, wherein the battery has an energy capacity of about 1800 mAh.

19. The charging apparatus as claimed in claim 17, wherein the battery has an energy capacity of about 2500 mAh.

20. A method for charging a portable electronic device, the method comprising:
providing a portable charging apparatus according to claim 1;
connecting the charger-side electrical connector of the portable charging apparatus to a device-side electrical connector of a portable electronic device.

21. The method as claimed in claim 20, wherein the portable charging apparatus includes a controller housed in the housing and operatively connected to the electrical power source and a switch operatively connected to the controller for selectively allowing and preventing supply of electrical power from the electrical power source to the portable electronic device, the method further comprising:
operating the switch to set the controller in a charging configuration in which electrical power is supplied from the electrical power source to the male electrical connector.

22. The method as claimed in claim 20, wherein providing the portable charging apparatus comprises:
providing a sealed package containing the portable charging apparatus;
opening the sealed package to access the portable charging apparatus.

23. The method as claimed in claim 20, further comprising:
after the electrical power source has been depleted, disposing of the portable charging apparatus.

24. The method as claimed in claim 20, further comprising:
after the electrical power source has been at least partially depleted, recharging the electrical power source.

25. A portable charging apparatus for charging a portable electronic device, the apparatus comprising:
an apparatus body including a housing and an electrical power source housed within the housing;
a charging head distinct from the apparatus body, the charging head including an elongated body and a male electrical connector extending from the body for engaging a corresponding female electrical connector of the portable electronic device;
a connection cable extending between the apparatus body and the charging head to allow the charging head to be disposed away from the apparatus body, the connection cable having a proximal end operatively connected to the electrical power source and a distal end operatively connected to the male electrical connector to allow electrical power to be provided from the electrical power source to the male electrical connector, the proximal end of the connection cable being permanently secured to the apparatus body.
